(19) United States
(12) Patent Application Publication
(10) Pub. No.: US 2006/0005121 A1
(43) Pub. Date: Jan. 5, 2006

(54) Discretization of dimension attributes using data mining techniques

(75) Inventors: Alexander Berger, Sammamish, WA (US); Edward Melomed, Kirkland, WA (US); Raman Iyer, Redmond, WA (US); Thulusalamatom Krishnamurthi Anand, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/881,262

(22) Filed: Jun. 30, 2004

(51) Int. Cl. G06F 17/30

(52) U.S. Cl. 715/513

(57) ABSTRACT

In order to allow the use of data in dimension attributes for grouping members of a dimension, dimension attribute data is analyzed so it can be used as if it were data for a categorical attribute with a manageable number of states. The values possible for the dimension attribute are divided into groups. This is done by determining the distribution of data. An approximate distribution may be determined (by sampling some data) or an actual distribution may be determined (by sampling all data). The distribution is then used to determine the groups into which the range of data values will be divided. Each group is then treated as if it were a state for a categorical-type dimension attribute. A state can be determined for a member by determining which subrange contains the value for the dimension attribute for the member. The number of groups can be determined by a user or determined dynamically, e.g. to best fit the distribution found. The group data may be stored in order to allow further conversion of future cases.

### FIELD OF THE INVENTION

This invention relates in general to the field of data analysis and online analytical processing. More particularly, this invention relates to the use of online analytical processing attributes using data mining techniques.

### BACKGROUND OF THE INVENTION

Data Mining

Data mining is a general term for a field of computing in which trends, patterns, and relationships are uncovered from accumulated electronic data. Data mining (sometimes termed “knowledge discovery”) allows the use of a data store by examining the data for patterns, e.g., to suggest better ways to produce profit, savings, higher quality products, and greater customer satisfaction. Data mining is used to sift through large amounts of data and the associated many competing and potentially useful dimensions of analysis and associated combinations.

For example, a business may amass a large collection of information about its customers. This information may include purchasing information and any other information available to the business about the customer. The predictions of a model associated with customer data may be used, for example, to control customer attrition, to perform credit-risk management, to detect fraud, or to make decisions on marketing.

Intelligent cross-selling support may be provided. For example, the data mining functionality may be used to suggest items that a user might be interested in by correlating properties about the user, or items the user has ordered, with a database of items that other users have ordered previously. Users may be segmented based on their behavior or profile. Data mining allows the analysis of segment models to discover the characteristics that partition users into population segments. Additionally, missing values in user profile data may be predicted. For example, where a user did not supply data, the value for that data may be predicted.

Data Warehousing and OLAP

Online analytical processing (OLAP) is a key part of many data warehouse and business analysis systems. OLAP services provide for fast analysis of multidimensional information. For this purpose, OLAP services provide for multidimensional access and navigation of data in an intuitive and natural way, providing a global view of data that can be drilled down into particular data of interest. Speed and response time are important attributes of OLAP services that allow users to browse and analyze data online in an efficient manner. Further, OLAP services typically provide analytical tools to rank, aggregate, and calculate lead and lag indicators for the data under analysis.

In this context, an OLAP cube may be modeled according to a user's perception of the data. The cube may have multiple dimensions, each dimension modeled according to attributes of the data. Typically, there is a hierarchy associated with each dimension. For example, a time dimension can consist of years subdivided into months subdivided into weeks subdivided into days, while a geography dimension can consist of countries subdivided into states subdivided into cities. Dimension members can act as indices for identifying a particular cell or range of cells within the cube.

OLAP services are often used to analytically model data that is stored in a relational database such as, for example, an Online Transactional Processing (OLTP) database. Data stored in a relational database may be organized according to multiple tables with each table having data corresponding to a particular data type. A table corresponding to a particular data type may be organized according to columns corresponding to data attributes

The data stored, for example, may represent the business history of an organization. This historical data is used for analysis. In the case of business history data, the analysis can be used to support business decisions at many levels, from strategic planning to performance evaluation of a discrete organizational unit. Data in a data warehouse is organized to support analysis rather than to process real-time transactions as in online transaction processing systems (OLTP).

Online analytical processing (OLAP) technology enables data warehouses to be used effectively for such analysis, providing rapid responses to iterative complex analytical queries. OLAP uses a multidimensional data model and data aggregation techniques to organize and summarize large amounts of data so the data can be evaluated quickly using online analysis and graphical tools. The answer to a query into historical data often leads to subsequent queries as the analyst searches for answers or explores possibilities. OLAP systems provide the speed and flexibility to support the analyst in real time.

Whereas data warehouses and data marts are the data stores for analysis data, online analytical processing (OLAP) is the technology that enables client applications to efficiently access this data. OLAP provides many benefits to analytical users, for example:
An intuitive multidimensional data model makes it easy to select, navigate, and explore the data.
An analytical query language provides power to explore complex business data relationships.
Precalculation of frequently queried data enables very fast response time to ad hoc queries.

In many cases, OLAP uses a dimensional data scheme in order to effect these benefits. For example, multidimensional OLAP cubes are created from the available data. A cube is a specialized database that is optimized to combine, process, and summarize large amounts of data in order to provide answers to questions about that data in the shortest amount of time. This allows users to analyze, compare, and report on data in order to spot business trends, opportunities, and problems. A cube uses pre-aggregated data instead of aggregating the data at the time the user submits a query. Queries are run against these cubes.

The queries of a user yield dimensions of data, which the user can browse in order to view the responsive data. Dimensions may have dimension attributes, which include information about the members of the dimension. For example, a geographical state dimension will allow the dimension to be browsed by state. Some dimension attributes are categorical. Such attributes categorize the members of the dimension into one of several pre-defined states.

Dimensions may include dimension attributes which are continuous. A continuous dimension attribute is one where the value for the attribute may be anywhere within a range of possible values. For example, one such attribute may correspond to the age of a customer. Associated with the age attribute is a range of possible values for the attribute. As another example, cases may correspond to different machine parts. One continuous attribute in the data set may be the weight of the machine part as expressed in milligrams. Browsing a dimension by a continuous dimension attribute may be impossible or useless to the user, because of the infinite possible values for the continuous dimension attribute.

Another type of continuous dimension attribute may be non-numeric, such as city information. While state information may be seen as a categorical dimension attribute, with 50 possible states, city information may not be limited to a set number of cities. Even where the dimension attribute is not continuous (e.g. because there are only a certain number of states) the browsing of a dimension by a dimension attribute with a great number of possible values may not be useful.

One method in which a dimension may be browsed by a dimension attribute which is continuous is through simple discretization. In discretization, the continuous attribute is divided into a number of states by dividing the possible range for the continuous attribute equally into a fixed number of subranges. Each subrange is treated as a distinct state which may be browsed separately.

However, this brute force solution may not provide the most useful division of data into ranges. For example, a continuous attribute may allow for values between Vₘᵢₙ and Vₘₐₓ. This range may be divided into ten subranges, R₁, R₂, though R₁₀. If, however, most of the data for a dimension falls into range R₄, then the discretization of the continuous attribute may yield little useful information for the browsing user. If all of the data falls into range R₄, then no gain would be realized by performing this discretization.

Thus, there is a need for a way to allow dimension attributes to be used for browsing or examination of a dimension or other collection of data, in a way which allows the information contained in the dimension attribute to be more effectively used.

### SUMMARY OF THE INVENTION

In OLAP data structures or other data modeling contexts, members of a dimension are grouped by allowing one dimension attribute to be discretized. In order to perform this discretization, the distribution of values for the dimension attribute is examined. Values for the dimension attribute for the entire dimension being examined may be considered to determine this distribution, or an approximate distribution may be obtained by using only sample data from the dimension.

Once this distribution is obtained, it is examined in order to divide the range of the dimension attribute into groups or subranges. These groups are then used as “buckets” for the discretization of the dimension attribute. A number of such subranges/buckets are determined. The dimension attribute can then be treated as a categorical attribute, with the value for the categorical attribute for a dimension member with a specific value for the dimension attribute being equal to the state corresponding to the subrange into which that specific value falls. When the dimension is then browsed in an OLAP context, the resulting categorical attribute data may be used to group the members of the dimension being browsed.

Other embodiments are described below.

### BRIEF DESCRIPTION OF THE DRAWINGS

The foregoing summary, as well as the following detailed description of presently preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing environment in which aspects of the invention may be implemented;

FIG. 2A is a block diagram showing a stored data set such as an N-dimensional OLAP cube in which aspects of the invention may be implemented;

FIG. 2B is a block diagram showing a stored data set;

FIG. 3 is a graph of a distribution of values over a dimension;

FIG. 4 is a graph of a distribution of values over a dimension with a division into subranges;

FIG. 5 is a flow diagram of a method for grouping members of a dimension according to one embodiment of the invention; and

FIG. 6 is a flow diagram of a method for grouping additional cases according to one embodiment of the invention.

### DETAILED DESCRIPTION OF ILLUSTRATIVE EMBODIMENTS

Overview

In accordance with the invention, the data stored in a dimension for a dimension attribute is examined. The distribution of the values for that dimension attribute is determined. Based on the distribution, the range of values for the dimension attribute is divided into subranges.

The dimension attribute can then be treated as a categorical attribute, with the value for the categorical attribute for a member with a specific value for the dimension attribute being equal to the state corresponding to the subrange into which that specific value falls. When data is used, e.g. for browsing in an OLAP context, the resulting categorical attribute data may be used to group the members of the dimension.

Exemplary Computing Environment

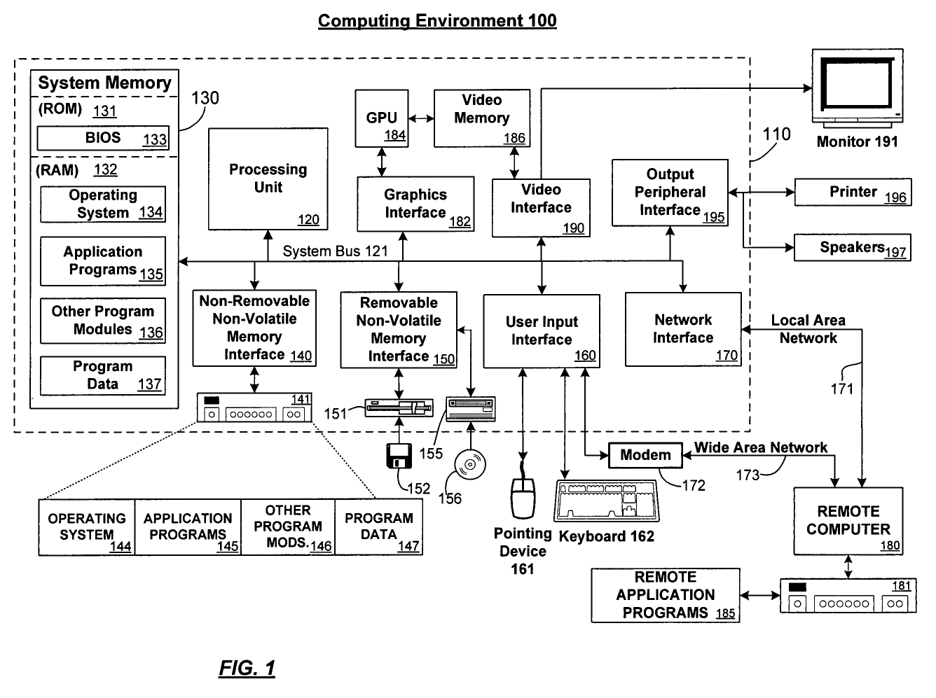

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes, which may be used in connection with the present invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices. Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the techniques of the present invention.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium that can be used to store the desired information and that can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

While some exemplary embodiments herein are described in connection with software residing on a computing device, one or more portions of the invention may also be implemented via an operating system, application programming interface (API) or a “middle man” object, a control object, hardware, firmware, etc., such that the methods may be included in, supported in or accessed via all of NET's languages and services, and in other distributed computing frameworks as well.

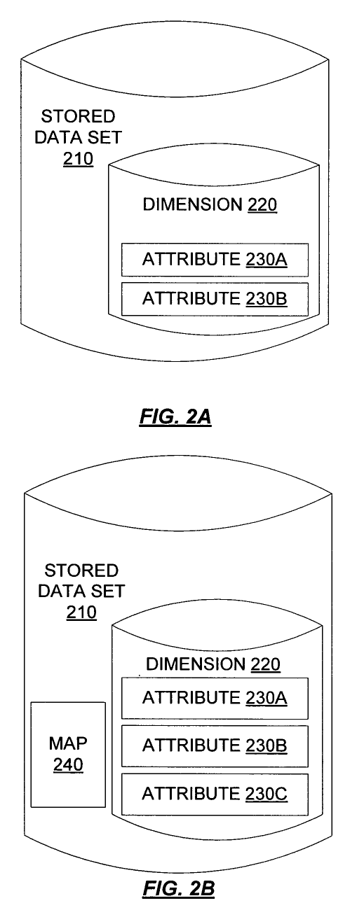

FIG. 2A is a block diagram showing a stored data set 210. The stored data set may be, e.g., an OLAP cube. Within the stored data set 210 is a dimension 220. Dimension 220 may be precomputed or may be computed in response to a query. Dimension 220 includes dimension attributes 230A and 230B. Although not shown, the stored data set 210 may include other dimensions and other attributes.

As described above, attributes may be of different types, such as continuous or categorical. Where a continuous-type dimension attribute is included in a dimension it may be less useful for browsing or other purposes than a categorical-type dimension attribute would be. Additionally, when a categorical-type dimension has too many states, it may be difficult to browse the dimension. Thus, according to the present invention, the values in a dimension for a dimension attribute are examined.

In order to discretize a dimension attribute, the distribution of the values for the dimension attribute is determined. This distribution may either be obtained by determining all values in the dimension for the dimension attribute, or by randomly or pseudo-randomly selecting a sample of values for the dimension attribute from the dimension. The distribution of values is then used in order to select subranges of the range of values for the dimension attribute to use as buckets or states for grouping the members of the dimension.

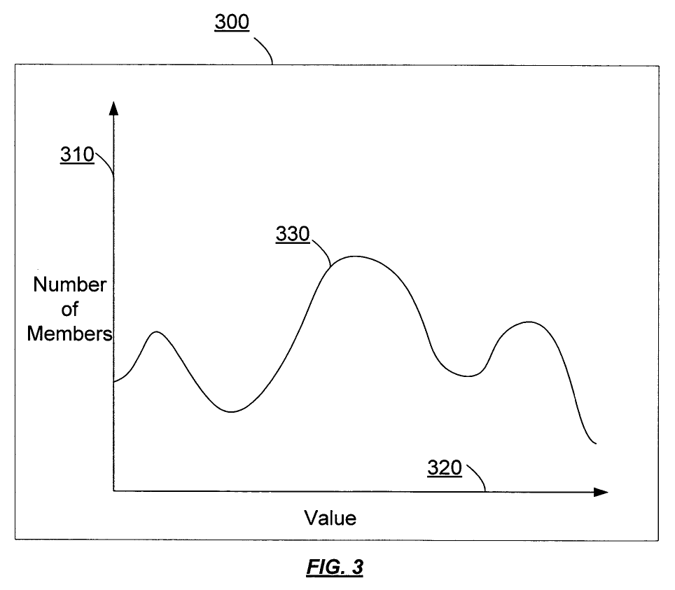

FIG. 3 is a graph of a distribution of values over a dimension. This graph allows the distribution created to be visualized; however, the actual production of such a graph is not required in order to practice the inventive techniques according to some embodiments of the invention. FIG. 3 shows a graph 300 which plots the number of members with a specific value. For distribution curve 330, the X-axis 320 value represents values for the dimension attribute, and the Y-axis 310 value represents the number of members in the dimension (or in the sample used from the dimension) with that value. The range of possible values is divided into a number of subranges, also known as buckets, which correspond to states for a categorical attribute.

FIG. 2B is a block diagram showing a stored data set 210 with an additional dimension attribute. When the discretization is performed, in one embodiment, data for an additional dimension attribute 230C is created. The additional dimension attribute is a categorical-type attribute created by discretizing a first dimension attribute. FIG. 2B also shows a mapping 240 which is stored. This mapping stores the information used to create the categorical attribute. In this way, additional information can be added to the dimension and categorized in the same way as existing data. In an alternate embodiment, only the mapping 240 is stored, and it is used to allow browsing through an OLAP dimension.

Where the cases are contained in an OLAP structure, the categorical-type attribute information can be used for allowing browsing through a dimension. Browsing commands are accepted from a user, and these browsing commands allow the use of the categorical-type attribute information to select cases for display to the user.

Producing the Subranges

The number of buckets or states to use for the new categorical attribute may be selected by the user. Alternatively, it may be selected dynamically and automatically based on the distribution and the method used to produce the subranges. Some methods of producing subranges may include a method of determining how many subranges there should be. For example, as described below, the agglomeration clustering method can include a way of reducing the number of clusters until a preferred clustering is reached.

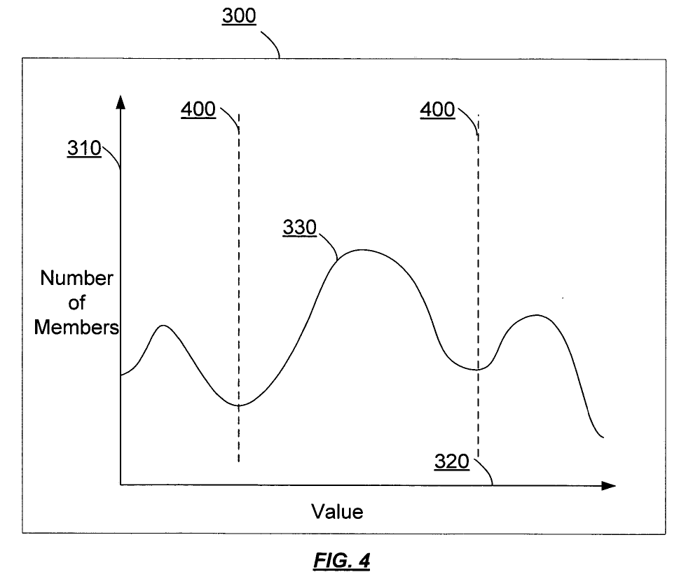

As can be seen in FIG. 3, distribution curve 330 may be interpreted to include three distinct groupings of members, and so it may be the case that the user or the automatic selection may decide that three subranges should be selected. FIG. 4 is a graph of a distribution of values over a number of members with a division into subranges. As shown in FIG. 4, the subranges may be divided as shown by subrange boundary lines 400. However, if the number of buckets is selected by the user or otherwise to be greater than or less than three, another division of the range will be performed, which separates the range into the correct number of subranges.

The division of a distribution of values into groupings with significance (rather than a random division of values) is a mathematical problem which has been and continues to be solved in different ways. Both the selection of the number of buckets or states and the actual division of the distribution into subranges may be done by any process.

K-Means

One method which may be used is by performing single-dimensional clustering using the K-Means algorithm. In one embodiment, in order to perform the K-means algorithm, K random locations L₁ to L_{K} are selected along the distribution. The datapoints (the values in the data set or sample in the distribution) are then each assigned to the closest of the K random locations. For any location Lₙ of the K random locations, then, a group of data points has been assigned to that location Lₙ. A new location is then determined based on data points assigned to the location. For example, the mathematical average of the data points may be determined, and the new location Lₙ′ set to that average. A number of iterations are performed. The iterations may end at a predetermined iteration, or when the sum of the movements of the locations for the latest iteration is under a specific threshold.

After the K-means algorithm is performed, the subranges for the categorical attribute may then be determined. The K locations at the end of the iteration are the center of clusters. Therefore, if the final locations arranged from one a beginning of the possible range of values to the end are FL₁ through FL_{K}, then the first range would be from one end of the range to (FL₁+FL₂)/2. The second range would be from (FL₁+FL₂)/2 through (FL₂+FL₃)/2. The last range would be from (FL_{K-1}+FL_{K})/2 to the end of the range. This would produce K subranges for the categorical attribute.

Equal Areas

Another possible method for dividing the distribution into subranges is the equal areas method. In this method, the distribution of values across the population (the data set or sample) is analyzed. Bucket ranges are then created such that the total population is distributed equally across the buckets. Thus, under this method, the area under the curve 300 in FIG. 4 for each subrange is equal.

Equal areas may be used to divide a distribution into groups even where the dimension attribute is not a numeric attribute. Thus, where the dimension attribute is geographic, into cities, the dimension attribute may be divided into groups such that each group contains approximately the same number of members.

Thresholds

A third possible method for dividing the distribution into subranges according to one embodiment of the invention is by identifying inflection points in the distribution curve. These points correspond to gradient changes from positive to negative. For example, the two subrange boundary lines 400 in FIG. 4 are located at this point on the X-axis 320. These points are then used as the boundaries for the subranges.

Agglomeration Clustering

A fourth possible method for dividing the distribution into subranges according to one embodiment of the invention is agglomeration clustering. Each case is initially assigned its own cluster. Then, iteratively, all pairs of groups are evaluated and the pair that is closest is found. Closeness may be determined, for example, by comparing the average value in the clusters. The closest clusters are merged into a single group.

This process continues until either the closest clusters do not meet some guideline. For example, if the closest clusters are not close enough, using a threshold value, they may not be merged. Alternatively, the process may continue until a predetermined required number of clusters are achieved. Subranges are then selected so that the values in each cluster are all assigned to one subrange.

Data Set Conversion

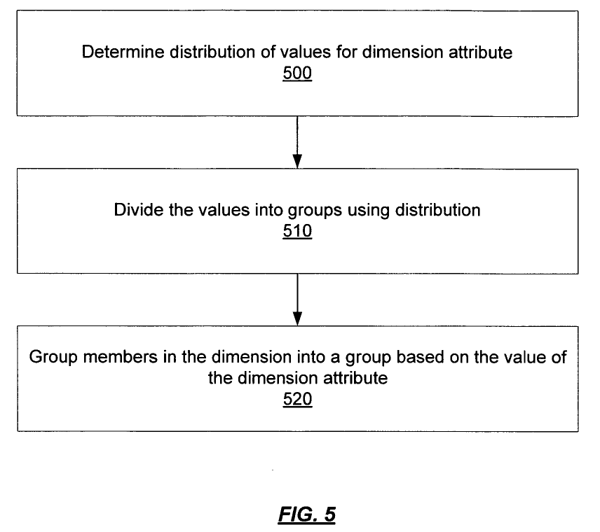

FIG. 5 is a flow diagram of a method for grouping members of a dimension according to one embodiment of the invention. First, as shown in step 500, a distribution of the values for the dimension attribute is determined. Then, in step 510, the distribution may be used to divide the values for the dimension attribute into groups. In one embodiment, where the values are susceptible to ordering, these groups are subranges of the range of values for the dimension attribute. The number of groups may also be determined in this step using the distribution. The number of groups may also be preset, or determined by the user. Once this is done, as shown in step 520, grouping of some members in the dimension into one of the groups occurs, by determining into which group the value for the dimension attribute falls.

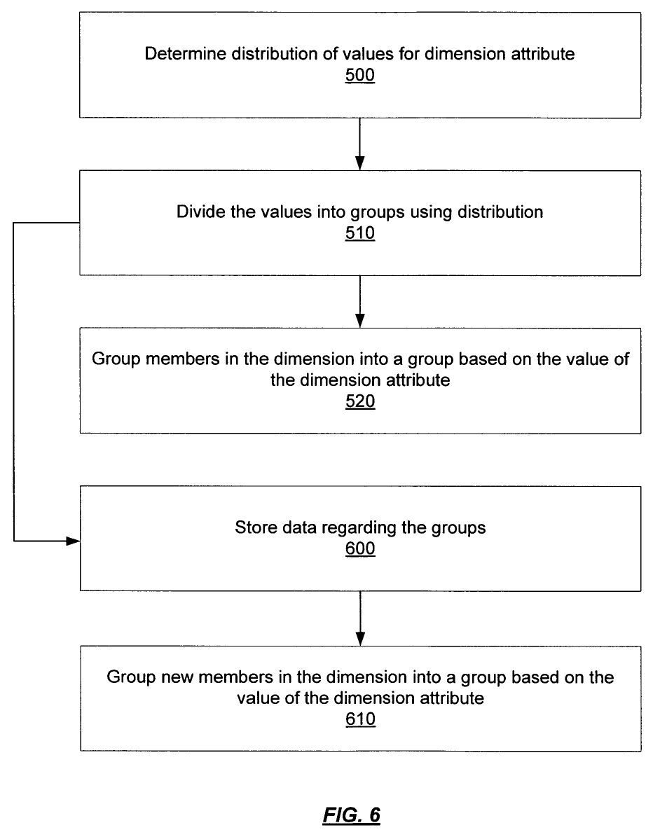

FIG. 6 is a flow diagram of a method for grouping additional cases according to one embodiment of the invention. In addition to the steps shown in FIG. 5, FIG. 6 includes step 600, in which data regarding the groups is stored, and step 610, in which the groups are applied to group additional data. In this way, the distribution created in step 510 can be used to create grouping divisions for a dimensional attribute (step 520), and then these grouping divisions can be used for additional data.

Naming of Groups/Buckets

In order to enhance user convenience when dealing with the groups which have been created, the groups or buckets which have been generated may be named. Group or bucket name generation may be performed according to the following grammar:

Bucket Naming template = “Name of first bucket” + ; +

“Name of intermediate bucket” + ; + “name of last bucket”

Bucket name -> “Bucket name” | “Any String” |

%{First bucket member} |
%{Last bucket member} |
%{Previous bucket last member} |
%{Next bucket first member} |

%{Bucket Min} |

%{Bucket Max} |
%{Previous Bucket Max} |
%{Next Bucket Min}

A template string could be applied which allows the buckets to be named using this grammar. For example, where the template string is:

“Salary less than %{Last bucket member} ; Salary range from

%{First bucket member} to %{Last bucket member} ; Salary from
%{First bucket member} and higher”

The generated names are:
“Name of first bucket” = “Salary less than %{Last bucket

member}”

“Name of intermediate bucket” = “Salary range from

%{First bucket member} to %{Last bucket member}”

“Name of last bucket” = “Salary from %{First bucket

member} and higher”

And the group names for this attribute would be:
First bucket = “Salary less than 10k” [symbol]
.
Intermediate= “Salary range from 30k to 40k” [symbol]
.
Last bucket = “Salary from 100k and higher”

### CONCLUSION

There are multiple ways of implementing the present invention, e.g., an appropriate API, tool kit, driver code, operating system, control, standalone or downloadable software object, etc. which enables applications and services to use the product configuration methods of the invention. The invention contemplates the use of the invention from the standpoint of an API (or other software object), as well as from a software or hardware object that communicates in connection with product configuration data. Thus, various implementations of the invention described herein may have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which it is desirable to implement product configuration. Thus, the techniques for encoding/decoding data in accordance with the present invention may be applied to a variety of applications and devices. For instance, the algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. With respect to embodiments referring to the use of a control for achieving the invention, the invention is not limited to the provision of a .NET control, but rather should be thought of in the broader context of any piece of software (and/ore hardware) that achieves the configuration objectives in accordance with the invention. One of ordinary skill in the art will appreciate that there are numerous ways of providing object code and nomenclature that achieves the same, similar or equivalent functionality achieved by the various embodiments of the invention. The term “product” as utilized herein refers to products and/or services, and/or anything else that can be offered for sale via an Internet catalog. The invention may be implemented in connection with an on-line auction or bidding site as well.

As mentioned, the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the product configuration techniques of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed:

1. A method for grouping members of a dimension for OLAP data, each of said members comprising a corresponding value for at least one dimension attribute, comprising:
determining a distribution of said corresponding values;
using said distribution to divide said corresponding values into at least two groups; and
determining a specific group from among said at least two groups to assign for a given one of said members, where said group contains said corresponding value for said given member.

2. The method of claim 1, further comprising:
displaying selected cases from said dimension to a user based on said determination of a specific group.

3. The method of claim 2 where said step of displaying selected cases comprises accepting browsing commands from a user.

4. The method of claim 1, where determination of a distribution comprises determining an approximation of the distribution of said corresponding values in said dimension using a sample set of members selected from said dimension.

5. The method of claim 1, where the number of groups is determined by a user.

6. The method of claim 1, where the number of groups is determined dynamically.

7. The method of claim 1, where said use of said distribution comprises using a K-means algorithm to create said groups.

8. The method of claim 1, where said use of said distribution comprises using an equal areas algorithm to create said groups such that, for each group, there are an approximately equal number of members for which the corresponding value falls in said group.

9. The method of claim 1, where said use of said distribution comprises determining at least one point where the gradient of said distribution changes from positive to negative and using said at least one point to determine said at least two groups.

10. The method of claim 1, where said use of said distribution comprises using an agglomeration clustering algorithm to create said groups.

11. The method of claim 1, where further members are added to said dimension, said method further comprising:
storing data regarding said groups;
determining a specific group from among said at least two groups for a given one of said further members.

12. A computer-readable medium having computer-executable instructions for grouping members of a dimension for OLAP data, each of said members comprising a corresponding value for at least one dimension attribute, said instructions for performing steps comprising:
determining a distribution of said corresponding values;
using said distribution to divide said corresponding values into at least two groups; and
determining a specific group from among said at least two groups to assign for a given one of said members, where said group contains said corresponding value for said given member.

13. The computer-readable medium of claim 12, said steps further comprising:
displaying selected cases from said dimension to a user based on said determination of a specific group.

14. The computer-readable medium of claim 13 where said step of displaying selected cases comprises accepting browsing commands from a user.

15. The computer-readable medium of claim 12, where determination of a distribution comprises determining an approximation of the distribution of said corresponding values in said dimension using a sample set of members selected from said dimension.

16. The computer-readable medium of claim 12, where the number of groups is determined by a user.

17. The computer-readable medium of claim 12, where the number of groups is determined dynamically.

18. The computer-readable medium of claim 12, where said use of said distribution comprises using a K-means algorithm to create said groups.

19. The computer-readable medium of claim 12, where said use of said distribution comprises using an equal areas algorithm to create said groups such that, for each group, there are an approximately equal number of members for which the corresponding value falls in said group.

20. The computer-readable medium of claim 12, where said use of said distribution comprises determining at least one point where the gradient of said distribution changes from positive to negative and using said at least one point to determine said at least two groups.

21. The computer-readable medium of claim 12, where said use of said distribution comprises using an agglomeration clustering algorithm to create said groups.

22. The computer-readable medium of claim 12, where further members are added to said dimension, said steps further comprising:
storing data regarding said groups;
determining a specific group from among said at least two groups for a given one of said further members.

23. A data converter for grouping members of a dimension for OLAP data, each of said members comprising a corresponding value for at least one dimension attribute, comprising:
a distribution determiner for determining a distribution of said corresponding values;
a range divider for using said distribution to divide said corresponding values into at least two groups; and
a group assigner for determining a specific group from among said at least two groups to assign for a given one of said members, where said group contains said corresponding value for said given member

24. The data converter of claim 23, further comprising:
a display for displaying selected cases from said dimension to a user based on said determination of a specific group.

25. The data converter of claim 24 further comprising:
a command accepter for accepting browsing commands from a user.

26. The data converter of claim 23, where determination of a distribution comprises determining an approximation of the distribution of said corresponding values in said dimension using a sample set of members selected from said dimension.

27. The data converter of claim 23, where the number of groups is determined by a user.

28. The data converter of claim 23, where the number of groups is determined dynamically.

29. The data converter of claim 23, where said use of said distribution comprises using a K-means algorithm to create said groups.

30. The data converter of claim 23, where said use of said distribution comprises using an equal areas algorithm to create said groups such that, for each group, there are an approximately equal number of members for which the corresponding value falls in said group.

31. The data converter of claim 23, where said use of said distribution comprises determining at least one point where the gradient of said distribution changes from positive to negative and using said at least one point to determine said at least two groups.

32. The data converter of claim 23, where said use of said distribution comprises using an agglomeration clustering algorithm to create said groups.
